(19) United States
(12) Patent Application Publication
(10) Pub. No.: US 2025/0144980 A1
(43) Pub. Date: May 8, 2025

(54) AIR VENT

(71) Applicant: HYUNDAI MOBIS CO., LTD., Seoul (KR)

(72) Inventor: Young Kyoung CHO, Yongin-si (KR)

(73) Assignee: HYUNDAI MOBIS CO., LTD., Seoul (KR)

(21) Appl. No.: 18/664,061

(22) Filed: May 14, 2024

(30) Foreign Application Priority Data
Nov. 8, 2023 (KR) 10-2023-0153447

(51) Int. Cl. B60H 1/34; B60H 1/00

(52) U.S. Cl. CPC B60H 1/3421; B60H 1/0065

(57) ABSTRACT

An air vent may comprise an air outlet that is open on one side and discharges air, a first wing that is disposed on the open side of the air outlet and guides air upward or downward by rotating up and down, a second wing that is disposed at a rear side of the first wing and guides air to the left or right by rotating left or right, and a knob that is movable forward and backward and interlocks with the first wing or the second wing depending on disposition thereof, and the knob may be disposed outside the air outlet.

### CROSS-REFERENCE TO RELATED APPLICATION

This application claims priority to and the benefit of Korean Patent Application No. 10-2023-0153447, filed on Nov. 8, 2023, the disclosure of which is incorporated herein by reference in its entirety.

### BACKGROUND

### Field of the Invention

The present invention relates to an air vent, and more specifically, to an air vent capable of adjusting a wind direction by disposing a knob outside an air outlet.

### Discussion of Related Art

An air vent is positioned at the end of an air flow path formed in a vehicle air conditioning system, and is a portion through which air is discharged. The air vent discharges air into a vehicle and adjusts the air condition inside the vehicle, and since the air vent discharges air inside the vehicle where passengers are, a knob is applied to adjust a direction of air discharge.

For air vents used in the related art, a knob is disposed on an air outlet, and a passenger may adjust a wind direction by moving the knob up and down or left and right. However, when the knob is disposed on the air outlet, the knob may apply resistance to discharged air and interfere with a direction of the discharged air.

In recent years, there have been attempts to implement a slim-shaped air vent for excellent design inside the vehicle, but there are limits to reducing the size of the knob, and thus an air vent in which the knob is removed from the air outlet is being studied.

### SUMMARY OF THE INVENTION

One embodiment of the present invention is directed to providing an air vent capable of implementing up and down wind and left and right wind through a knob for adjusting a wind direction by disposing the knob outside an air outlet of the air vent.

Problems to be solved by the present invention are not limited to those mentioned above, and other problems not mentioned will be clearly understood by those skilled in the art from the following description.

According to an aspect of the present invention, there is provided an air vent including an air outlet that is open on one side and discharges air, a first wing that is disposed on the open side of the air outlet and guides air upward or downward by rotating up and down, a second wing that is disposed at a rear side of the first wing and guides air to the left or right by rotating left or right, and a knob that is movable forward and backward and interlocks with the first wing or the second wing depending on disposition thereof.

The knob may be disposed outside the air outlet.

A rotating shaft may be formed to extend on a rear surface of the knob, a first gear and a second gear may be formed on the rotating shaft at a predetermined interval in a radial direction of the rotating shaft, and the first gear may interlock with the first wing and the second gear may interlock with the second wing so that when the knob is rotated, the first wing or the second wing is moved.

The air vent may further include protrusion that protrudes from a side surface of the first wing and has a bent end, and a first cam that is disposed parallel to the air outlet at a rear side of the knob and has a through hole formed so that the end of the protrusion passes therethrough.

The protrusion may be disposed at a predetermined interval from a rotating shaft of the first wing so that when the first cam rotates, the protrusion moves up and down to allow the first wing to rotate.

The air vent may include a link portion that is connected to one side of the second wing and has a bent end and a second cam that is disposed parallel to the air outlet at a rear side of the knob and has a through hole formed so that the end of the link portion passes therethrough.

When the second cam rotates, the link portion hung on the second cam may move left and right to allow the second wing to rotate left and right.

Gear protrusions may be formed on facing surfaces of the first cam and the second cam, and when the knob is moved forward and backward, the first gear or the second gear may interlock with the gear protrusion formed on the first cam or the second cam.

A distance between the first cam and the second cam may be formed to be greater than a distance between the first gear and the second gear formed on the rotating shaft of the knob.

The first gear and the second gear may be disposed in a space between the first cam and the second cam.

When the knob is disposed forward, the first gear may engage and interlock with the gear protrusions formed on the first cam, and when the knob is disposed backward, the second gear may engage and interlock with the gear protrusions formed on the second cam.

In a case where the knob interlocks with the first cam, when the knob is rotated, the first cam may rotate, which rotates the protrusion up and down to allow the first wing to rotate up and down, and in a case where the knob interlocks with the second cam, when the knob is rotated, the second cam may rotate, which moves the link portion left and right to allow the second wing to rotate left and right.

The knob may be initially disposed in a position where at least one of the first gear or the second gear interlocks with the first cam or the second cam, and an elastic body for providing an elastic force to maintain a state in which the knob is disposed in its initial position may be disposed on the rotating shaft of the knob.

Holes may be formed in centers of the first cam and the second cam so that the rotating shaft extending from the knob is movable forward and backward through the first cam and the second cam.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view of an air vent according to one embodiment of the present invention;

FIG. 2 is a view showing the air vent according to one embodiment of the present invention;

FIG. 3 is a view showing a knob and a cam of the air vent according to one embodiment of the present invention;

FIG. 4 is a view showing a first cam according to one embodiment of the present invention;

FIG. 5 is a view showing a second cam according to one embodiment of the present invention;

FIG. 6 is a view showing a state in which the second cam and the knob interlock according to one embodiment of the present invention;

FIG. 7 is a view showing a state in which the first cam and the knob interlock according to one embodiment of the present invention;

FIG. 8 is a view showing movement of a first wing according to one embodiment of the present invention; and

FIG. 9 is a view showing movement of a second wing according to one embodiment of the present invention.

### DETAILED DESCRIPTION OF EXEMPLARY EMBODIMENTS

Since the present invention may be variously modified and embodied, particular embodiments thereof will be illustrated in the drawings and described in detail. However, this is not intended to limit the present invention to the specific embodiments, and it should be understood to include all modifications, equivalents, and substitutes included in the spirit and scope of the present invention. In describing the present invention, when it is determined that the detailed description of the related known technology may obscure the subject matter of the present invention, the detailed description thereof will be omitted.

Terms “first,” “second,” etc., may be used herein to describe various elements, but the elements should not be limited by the terms. These terms are only used to distinguish one element from another element.

The terms used in the present application are merely provided to describe specific embodiments, and are not intended to limit the present invention. The singular forms are intended to include the plural forms as well, unless the context clearly indicates otherwise. In the present application, it will be understood that terms “include,” “have,” or the like are intended to specify the presence of features, integers, steps, operations, elements, components, and/or combinations thereof stated in the specification, but do not preclude the possibility of the presence or addition of one or more other features, integers, steps, operations, elements, components, or combinations thereof in advance.

In addition, throughout the specification, when “connected” is used, this does not only mean two or more components are directly connected, but means that two or more components are indirectly connected through another component, that the components are not only physically connected, but also electrically connected, or that the components are integrated although the components are referred to as different names depending on a location or a function.

Further, when a component is described as being formed or disposed “on (above) or under (below)” of another component, the term “on (above) or under (below)” includes not only when two components are in direct contact with each other, but also when one or more of other components are formed or disposed between the two components. Further, when a component is described as being “on (above) or below (under),” the description may include the meanings of an upward direction and a downward direction based on one component.

Hereinafter, one embodiment of an air vent according to the present invention will be described in detail with reference to the accompanying drawings, and in giving description with reference to the accompanying drawings, identical or corresponding components will be assigned the same numbers and overlapping descriptions thereof will be omitted.

The air vent for discharging air into a vehicle may adjust a wind direction through a knob 400. In general, the knob 400 may be disposed inside an air outlet 100 of the air vent so that a user adjusts a wind direction by pushing the knob 400 up and down or left and right.

When the knob 400 is disposed inside the air outlet 100, the knob 400 may interfere with flow of discharged air, which may make it difficult to control the wind direction. In addition, in recent years, slim air vents have been designed, but when the knob 400 is positioned inside the air outlet 100, there is a limit to reducing the air vent due to the size of the knob 400.

The present invention provides an air vent in which the knob 400 may be disposed outside the air outlet 100, allowing easy adjustment of up and down and left and right wind directions.

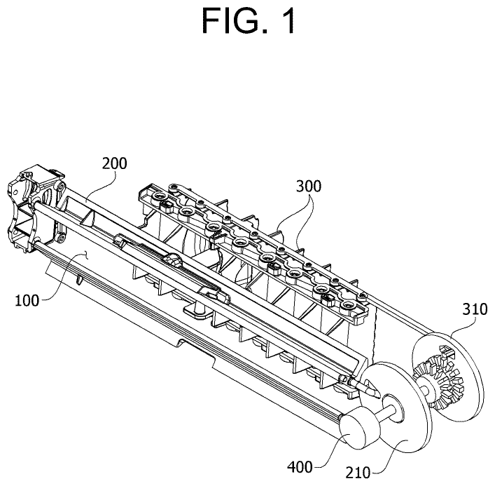

FIG. 1 is a perspective view of an air vent according to one embodiment of the present invention.

Referring to FIG. 1, the air vent according to one embodiment of the present invention may include a first wing 200 disposed inside the air outlet 100 and a second wing 300 disposed at a rear side of the first wing 200.

The first wing 200 may adjust a wind direction up and down, and the second wing 300 may rotate left and right to adjust the wind direction. It is possible to change the disposition of the first wing 200 and the second wing 300, and it is also possible for the first wing 200 to be disposed at a rear side of the second wing 300.

A knob 400 may be disposed on a side surface of the air outlet 100, the first wing 200, and the second wing 300. When the knob 400 interlocks with the first wing 200 or the second wing 300 depending on the disposition to rotate the knob 400, the first wing 200 or the second wing 300 may be moved so that the wind direction is adjusted.

The knob 400 is disposed outside the air outlet 100, and in the present embodiment, is shown as being disposed on the right side of the air outlet 100, but there is no limitation as long as the knob 400 may be disposed outside the air outlet 100 to easily adjust the wind direction.

The knob 400 may be disposed to be movable a predetermined distance forward and backward outside the air outlet 100. A user may adjust the position of the knob 400 in a way of pulling or pushing the knob 400, the knob 400 may interlock with the first wing 200 or the second wing 300 depending on the disposition of the knob 400, and the wind direction may be adjusted by rotating the knob 400 to control the movement of the first wing 200 or the second wing 300.

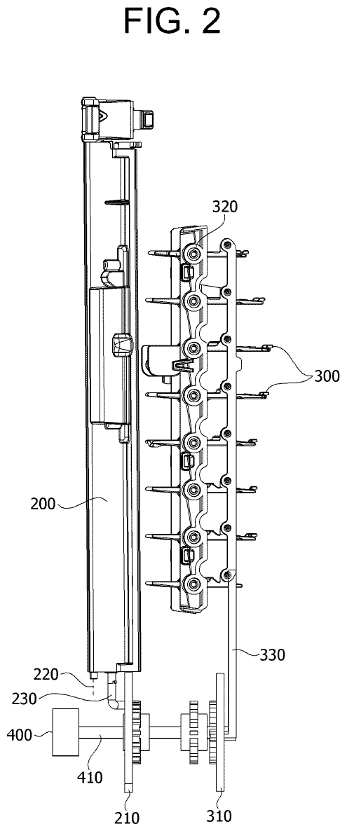

FIG. 2 is a view showing the air vent according to one embodiment of the present invention.

Referring to FIG. 2, the knob 400 may interlock with the first wing 200 and the second wing 300 through gears and cams. A rotating shaft 410 may be formed in the knob 400 in an inner direction. Two gears, that is, a first gear 420 and a second gear 430 may be disposed in a radial direction along the rotating shaft 410. The first gear 420 and the second gear 430 may be disposed at a predetermined interval.

Cams 210 and 310 may be disposed outside the rotating shaft 410 of the knob 400. The cams may include a first cam 210 connected to the first wing 200 and a second cam 310 connected to the second wing 300. The first cam 210 and the second cam 310 may rotate to allow the first wing 200 and the second wing 300 to be moved.

The first cam 210 and the second cam 310 may be disposed in a direction parallel to the air outlet 100, which corresponds to a plane perpendicular to the rotating shaft 410 extending from the knob 400. The first cam 210 and the second cam 310 may be disposed at a predetermined interval, and may be disposed at a wider interval than an interval between the first gear 420 and the second gear 430. That is, the first gear 420 and the second gear 430 may be disposed in the space between the first cam 210 and the second cam 310. This is to ensure that the knob 400 is moved forward and backward so that the first cam 210 or the second cam 310 and the first gear 420 or the second gear 430 interlock.

The first gear 420 and the second gear 430 may be disposed between the first cam 210 and the second cam 310, and by moving the knob 400 forward and backward, the first gear 420 or the second gear 430 may move together and interlock with the first cam 210 or the second cam 310. That is, depending on the disposition of the knob 400, only one of the first cam 210 or the second cam 310 may interlock to adjust an angle of the first wing 200 or the second wing 300.

As described above, in the present embodiment, the first wing 200 may be disposed inside the air outlet 100 and the second wing 300 may be disposed at the rear side of the first wing 200. A rotating shaft 220 of the first wing 200 is formed parallel to a longitudinal direction of the air outlet 100 in front of the first wing 200 and a part where the first wing 200 and the first cam 210 interlock is disposed at a rear side of the rotating shaft 220 so that the first wing 200 may rotate up and down about the rotating shaft 220.

The second wing 300 may include a plurality of wings 300 disposed parallel to a height direction of the air outlet 100, and each wing 300 may be disposed in parallel at a predetermined interval. A rotating shaft 320 of each wing 300 may be formed parallel to the height direction of the air outlet 100 and may rotate simultaneously.

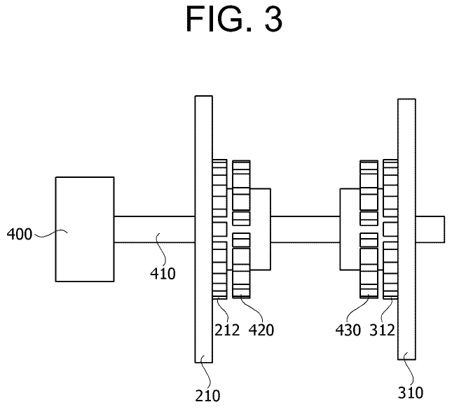

FIG. 3 is a view showing the knob and the cam of the air vent according to one embodiment of the present invention.

Referring to FIG. 3, the knob 400 and the cams 210 and 310 of the air vent according to one embodiment of the present invention may interlock through a gear structure. The rotating shaft 410 is formed to extend at the rear side of the knob 400, and the first gear 420 and the second gear 430 may be formed in the radial direction on the rotating shaft 410.

Gear protrusions 212 and 312 may be formed on the first cam 210 and the second cam 310, respectively, so that the first gear 420 and the second gear 430 interlock. In detail, holes 216 and 316 may be formed in a central portion corresponding to the rotating shaft 410 of the first cam 210 and the second cam 310 so that the rotating shaft 410 extending from the knob 400 passes therethrough. The first cam 210 and the second cam 310 may be disposed outside the first gear 420 and the second gear 430, and may be formed radially outside the rotating shaft 410. The gear protrusions 212 and 312 may be formed on facing surfaces of the first cam 210 and the second cam 310. The gear protrusions 212 and 312 may be formed to interlock with the first gear 420 and the second gear 430.

When the user pulls the knob 400 forward, the first gear 420 may engage and interlock with the gear protrusions 212 formed on the first cam 210. When the user pushes the knob 400 backward, the second gear 430 may engage and interlock with the gear protrusions 312 formed on the second cam 310.

In the present embodiment, the knob 400 and the rotating shaft 410 are shown as being disposed at the centers of the first cam 210 and the second cam 310, but the first cam 210 and the second cam 310 may be disposed on the side of the knob 400 and the rotating shaft 410, and may interlock with the first gear 420 and the second gear 430 formed on the knob 400. In detail, the first cam 210 and the second cam 310 may have a gear structure formed on their rims, and may engage and interlock with the first gear 420 and the second gear 430 disposed on the rotating shaft 410 of the knob 400. In this case, the knob 400, the first cam 210, and the second cam 310 rotate around separate rotating shafts.

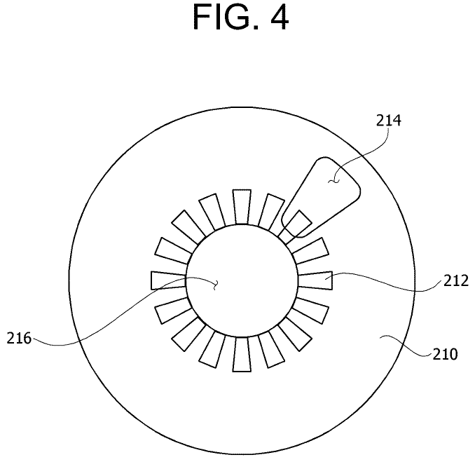

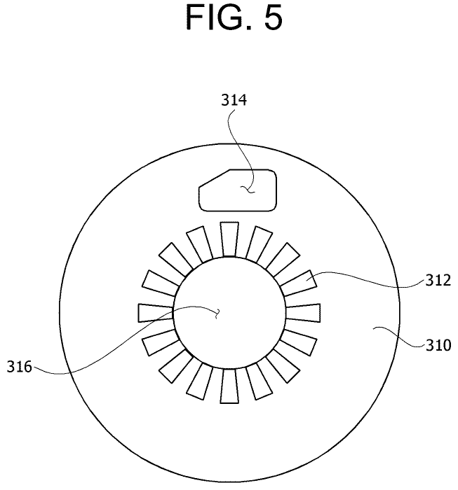

FIG. 4 is a view showing the first cam according to one embodiment of the present invention, and FIG. 5 is a view showing the second cam according to one embodiment of the present invention.

Referring to FIGS. 4 and 5, the first cam 210 and the second cam 310 according to one embodiment of the present invention may have through holes 214 and 314 formed to interlock with the first wing 200 and the second wing 300, and the gear protrusions 212 and 312 may be formed on the facing surfaces of the first cam 210 and the second cam 310.

The holes 216 and 316 may be formed at the centers of the first cam 210 and the second cam 310 so that the rotating shaft 410 connected to the knob 400 passes therethrough. The rotating shaft 410 may be disposed to pass through the holes 216 and 316 formed at the centers of the first cam 210 and the second cam 310, and when the knob 400 is rotated, the rotating shaft 410 may be rotated inside the holes 216 and 316 formed at the centers of the cams that does not interlock with the knob 400. The cams interlocking with the knob 400 may rotate together with the rotating shaft 410.

The gear protrusions 212 may be formed on the first cam 210 to interlock with the first gear 420. The gear protrusions 212 may be formed on a surface of the first cam 210 facing the second cam 310, and the surface corresponds to a rear surface of the first cam 210 based on the front of the vehicle air conditioning system. The gear protrusions 212 may be formed to protrude from one side of the first cam 210, and may be formed to correspond to a gear structure of the first gear 420.

In detail, since the first gear 420 is formed in the radial direction from the rotating shaft 410 connected to the knob 400, the gear protrusions 212 formed on the first cam 210 may be formed to have an empty center by including the hole 216 in which the rotating shaft 410 is disposed, and extend in the radial direction based on the rotating shaft 410. The gear protrusions 212 may be formed to correspond to gear grooves of the first gear 420, and may interlock with the first gear 420 by being inserted into the gear grooves.

The gear protrusions 312 may be formed on the second cam 310 to interlock with the second gear 430. The gear protrusions 312 may be formed on a surface of the second cam 310 facing the first cam 210, and the surface corresponds to a front surface of the second cam 310 based on the front of the vehicle air conditioning system. The gear protrusions 312 may be formed to protrude from one surface of the second cam 310, and may be formed to correspond to a gear structure of the second gear 430.

In detail, since the second gear 430 is formed in the radial direction from the rotating shaft 410 connected to the knob 400, the gear protrusions 312 formed on the second cam 310 may be formed to have an empty center by including the hole 316 in which the rotating shaft 410 is disposed, and extend in the radial direction based on the rotating shaft 410. The gear protrusions 312 may be formed to correspond to gear grooves of the second gear 430, and may interlock with the second gear 430 by being inserted into the gear grooves.

The first gear 420 and the second gear 430 may also be formed to the same specifications, and accordingly, the gear protrusion 212 of the first cam 210 and the gear protrusion 312 of the second cam 310 may also be formed to the same specifications.

A through hole 214 for interlocking with the first wing 200 may be formed in the first cam 210. For a protrusion 230 that protrudes from one side of the first wing 200 and has a bent end, the end may be hung in the through hole 214 of the first cam 210, thereby interlocking the first wing 200 and the first cam 210. When the first cam 210 interlocks with the knob 400 and rotates in a state in which the protrusion 230 is hung in the through hole 214 of the first cam 210, the protrusion 230 may rotate together to allow the first wing 200 to rotate up and down.

A through hole 314 for interlocking with the second wing 300 may be formed in the second cam 310. A link portion 330 may be connected to one side of the second wing 300. The link portion 330 may have a bent end, and the end may be hung in the through hole 314 formed in the second cam 310 so that the second cam 310 and the second wing 300 interlock. When the second cam 310 interlocks with the knob 400 and rotates in a state in which the link portion 330 is hung on the second cam 310, the link portion 330 may move left and right.

The through hole 214 of the first cam 210 may have an elongated hole shape extending radially around the rotating shaft 410 to rotate the protrusion 230 of the first wing 200 up and down. The through hole 314 of the second cam 310 may have an elongated hole shape wider in a direction perpendicular to a radial direction centered on the rotating shaft 410 to move the link portion 330 of the second wing 300 in a horizontal direction.

A method in which the first cam 210 and the second cam 310 and the first wing 200 and the second wing 300 interlock may be implemented through a slot and pin structure. In detail, a slot may be formed on one surface of each of the first cam 210 and the second cam 310, and pins may be formed to protrude from the ends of the first wing 200 and the second wing 300. The pins may be seated into the slots and moved by sliding inside the slots when the first cam 210 and the second cam 310 rotate. The shape of the slot may be formed to correspond to a direction in which the pin moves, and may be formed so that conversion of the rotational movement of the cams 210 and 310 into the linear movement of the pins is possible.

Rotation angles of the first wing 200 and the second wing 300 may have limitations. When the air discharged from the air outlet 100 discharges maximum upward wind, the first wing 200 may rotate upward at a maximum angle, and when the air discharges maximum leftward wind, the second wing 300 may rotate left as much as possible.

When there are limits to the rotation angles of the first wing 200 and the second wing 300, rotation angles of the first cam 210 and the second cam 310 interlocking therewith may have limits to correspond to the rotation angles of the first wing 200 and the second wing 300. Therefore, a stopper may be disposed on one side of each of the first cam 210 and the second cam 310 to fix the first cam 210 and the second cam 310 so that the first cam 210 and the second cam 310 rotate only up to the maximum rotation angles.

In this case, when the first cam 210 and the second cam 310 discharge air in a desired direction by rotating by the knob 400, the first cam 210 and the second cam 310 may be fixed to maintain corresponding dispositions. That is, movements of the first cam 210 and the second cam 310 may be fixed in respective dispositions. There may be a certain level of resistance on the rotating shaft 410 of the first cam 210 or the second cam 310 to prevent the rotating shaft 410 from rotating when the first cam 210 or the second cam 310 does not interlock with the knob 400.

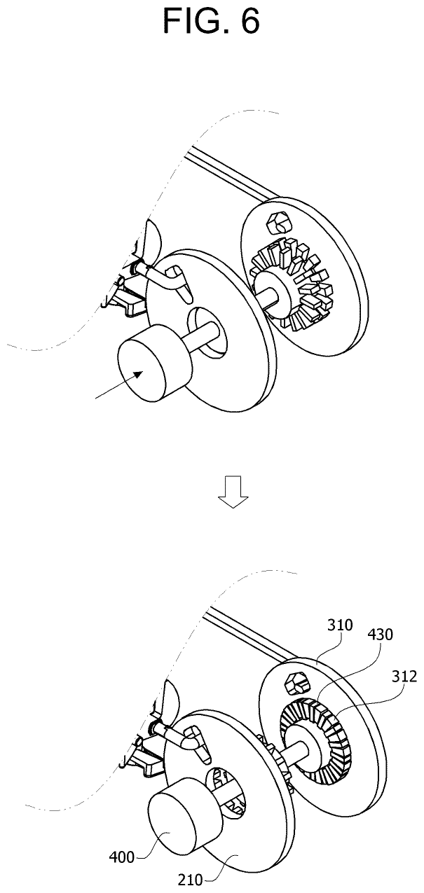

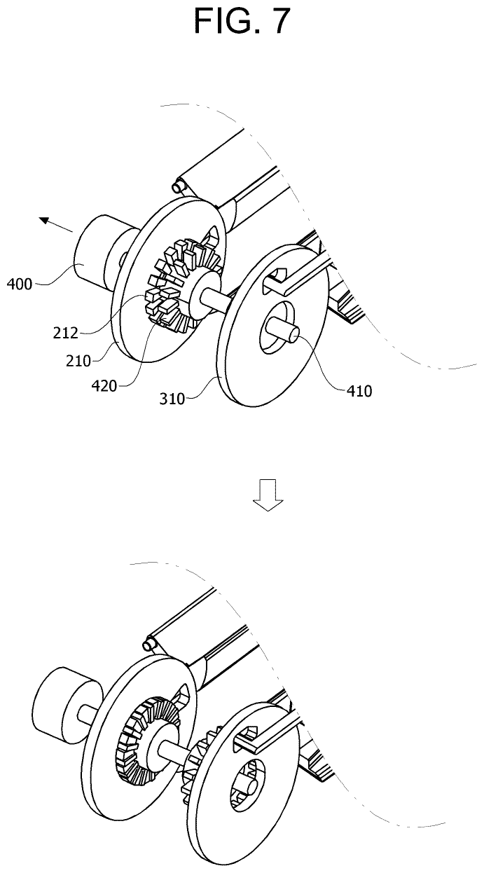

FIG. 6 is a view showing a state in which the second cam and the knob interlock according to one embodiment of the present invention, and FIG. 7 is a view showing a state in which the first cam and the knob interlock according to one embodiment of the present invention.

Referring to FIG. 7, when the knob 400 is pulled forward, the first gear 420 formed on the rotating shaft 410 engages with the gear protrusions 212 formed on the first cam 210, thereby interlocking the knob 400 and the first cam 210. Then, when the knob 400 is rotated clockwise or counterclockwise, the first wing 200 interlocking with the first cam 210 may rotate up and down.

Referring to FIG. 6, when the knob 400 is pushed backward, the second gear 430 formed on the rotating shaft 410 engages with the gear protrusions 212 formed on the second cam 310, thereby interlocking the knob 400 and the second cam 310. Then, when the knob 400 is rotated clockwise or counterclockwise, the second wing 300 interlocking with the second cam 310 may rotate left and right.

The initial disposition of the knob 400 may be a disposition in which the first gear 420 and the second gear 430 are positioned between the first cam 210 and the second cam 310 so that both the first gear 420 and the second gear 430 do not engage with the first cam 210 and the second cam 310. In this case, an elastic body may be disposed at an end of the rotating shaft 410 to apply an elastic force so that the knob 400 is fixable in the above-described position.

As one example, the elastic body may be a spring. The spring may be disposed at the end of the rotating shaft 410 to provide an elastic force in an axial direction. When the user pulls the knob 400, the spring may stretch and provide an elastic force in the direction of pushing the knob 400 forward, and when the user pushes the knob 400, the spring may provide an elastic force in the direction of pulling the knob 400 backward by being compressed. That is, when the user removes the force applied by pulling or pushing the knob 400, the first gear 420 and the second gear 430 may be positioned in a space between the first cam 210 and the second cam 310.

Alternatively, the initial disposition of the knob 400 may be a disposition in which the first gear 420 or the second gear 430 engages with the first cam 210 or the second cam 310. In this case, when the user does not apply any force to the knob 400, the knob 400 may maintain a state in which the first cam 210 engages with the first gear 420 or the second cam 310 engages with the second gear 430. The user may adjust the initially disengaged cam and gear to engage by pulling or pushing the knob 400 in a direction opposite to the elastic force.

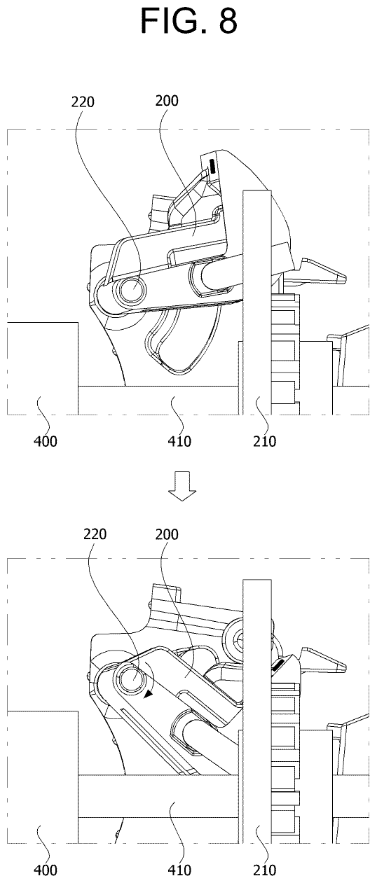

FIG. 8 is a view showing movement of the first wing according to one embodiment of the present invention.

Referring to FIG. 8, as the knob 400 is pulled forward, the first gear 420 may engage and interlock with the first cam 210, and as the user rotates the knob 400, the first cam 210 may rotate and the first wing 200 hung in the through hole 214 of the first cam 210 may rotate together. The rotating shaft 220 of the first wing 200 may be disposed in front of the first wing 200, allowing the first wing 200 to rotate up and down based on the rotating shaft 220 as the protrusion 230 formed to protrude from the rear of the first wing 200 and be bent rotates.

In the case of FIG. 8, when the knob 400 is rotated clockwise based on the front of the air vent, the protrusion 230 of the first wing 200 may rotate upward so that the first wing 200 is disposed to face downward to discharge a downward wind. When the knob 400 is rotated counterclockwise based on the front of the air vent, the protrusion 230 of the first wing 200 may rotate downward so that the first wing 200 is disposed to face upward to discharge an upward wind.

In order for the protrusion 230 of the first wing 200 to rotate up and down, the through hole 214 of the first cam 210 has to be moved up and down as the first cam 210 rotates. In order to implement up and down movement, the through hole 214 may be disposed on the left or right side of the first cam 210. That is, when the knob 400 is rotated clockwise or counterclockwise by a predetermined angle in a state in which the protrusion 230 of the first wing 200 is hung on the left or right side of the first cam 210, the protrusion 230 may be rotated to the lower or upper side of the first cam 210 to implement upward and downward winds. In the case of FIG. 1, the through hole 214 of the first cam 210 is shown as being disposed on the left side.

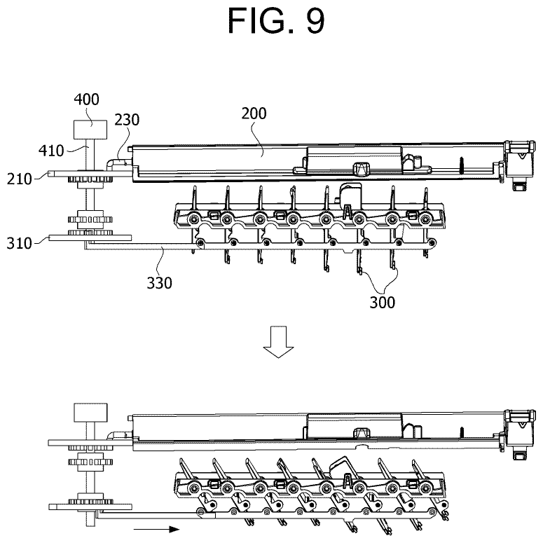

FIG. 9 is a view showing movement of the second wing according to one embodiment of the present invention.

Referring to FIG. 9, as the knob 400 is pushed rearward, the second gear 430 may engage and interlock with the second cam 310, and as the user rotates the knob 400, the second cam 310 may rotate and the second wing 300 hung on the through hole 314 of the second cam 310 may rotate together. The rotating shaft 320 of the second wing 300 may be formed to extend up and down based on the front of the air vent, and may rotate left and right. On one side of the second wing 300, the link portion 330 may interlock the second wing 300 and the second cam 310, and as the second cam 310 rotates, the link portion 330 may move left and right to allow the second wing 300 to rotate.

In the case of FIG. 9, when the knob 400 is rotated clockwise based on the front of the air vent, the link portion 330 may move left so that the second wing 300 is disposed to face right to discharge a rightward wind. When the knob 400 is rotated counterclockwise based on the front of the air vent, the link portion 330 may move right so that the second wing 300 is disposed to face left to discharge a leftward wind.

In order for the link portion 330 disposed on one side of the second wing 300 to move left and right, the through hole 314 of the second cam 310 has to be moved left and right according to the rotation of the second cam 310. To implement the left and right movement, the through hole 314 may be disposed on the upper or right side of the second cam 310. That is, when the knob 400 is rotated clockwise by a predetermined angle in a state in which the link portion 330 of the second wing 300 is positioned on the upper side of the second cam 310, the link portion 330 may move to the right or left of the first cam 210 to allow the second wing 300 to rotate so that the left and right wind is implemented. In the case of FIG. 1, the through hole 314 of the second cam 310 is shown as being disposed on the upper side.

According to one embodiment of the present invention, a wind direction can be adjusted up and down or left and right depending on front and rear disposition of a knob disposed outside an air outlet, so that no resistance is applied to the discharged air.

Various beneficial advantages and effects of the present invention are not limited by the contents described above and should be easily understood through a description of a detailed embodiment of the present invention.

Although the specific embodiments of the present invention have been described above, it is understood that one ordinary skilled in the art can make various changes and modifications to the present invention without departing from the spirit and scope of the present invention as hereinafter claimed.

What is claimed is:

1. An air vent comprising:
an air outlet that is open on one side and configured to discharge air;
a first wing that is disposed on the open side of the air outlet and is configured to guide air upward or downward by rotating up and down;
a second wing that is disposed at a rear side of the first wing and is configured to guide air to the left or right by rotating left or right; and
a knob that is movable forward and backward and is configured to interlock with the first wing or the second wing depending on disposition thereof,
wherein the knob is disposed outside the air outlet.

2. The air vent of claim 1, wherein a rotating shaft is formed to extend on a rear surface of the knob, a first gear and a second gear are formed on the rotating shaft at a predetermined interval in a radial direction of the rotating shaft, and the first gear is configured to interlock with the first wing and the second gear is configured to interlock with the second wing so that when the knob is rotated, the first wing or the second wing is moved.

3. The air vent of claim 2, further comprising:
a protrusion that protrudes from a side surface of the first wing and has a bent end; and
a first cam that is disposed parallel to the air outlet at a rear side of the knob and has a through hole formed so that the end of the protrusion passes therethrough,
wherein the protrusion is disposed at a predetermined interval from a rotating shaft of the first wing so that when the first cam rotates, the protrusion moves up and down to allow the first wing to rotate.

4. The air vent of claim 3, further comprising:
a link portion that is connected to one side of the second wing and has a bent end; and
a second cam that is disposed parallel to the air outlet at a rear side of the knob and has a through hole formed so that the end of the link portion passes therethrough,
wherein when the second cam rotates, the link portion hung on the second cam moves left and right to allow the second wing to rotate left and right.

5. The air vent of claim 4, wherein gear protrusions are formed on facing surfaces of the first cam and the second cam, and when the knob is moved forward and backward, the first gear or the second gear is configured to interlock with the gear protrusion formed on the first cam or the second cam.

6. The air vent of claim 5, wherein a distance between the first cam and the second cam is formed to be greater than a distance between the first gear and the second gear formed on the rotating shaft of the knob, and the first gear and the second gear are disposed in a space between the first cam and the second cam.

7. The air vent of claim 6, wherein when the knob is disposed forward, the first gear is configured to engage and interlock with the gear protrusions formed on the first cam, and when the knob is disposed backward, the second gear is configured to engage and interlock with the gear protrusions formed on the second cam.

8. The air vent of claim 7, wherein when the knob interlocks with the first cam and the knob is rotated, the first cam rotates, which rotates the protrusion up and down to allow the first wing to rotate up and down, and when the knob interlocks with the second cam and the knob is rotated, the second cam rotates, which rotates the link portion left and right to allow the second wing to rotate left and right.

9. The air vent of claim 7, wherein the knob is initially disposed in a position where at least one of the first gear or the second gear interlocks with the first cam or the second cam, and an elastic body for providing an elastic force to maintain a state in which the knob is disposed in its initial position is disposed on the rotating shaft of the knob.

10. The air vent of claim 9, wherein holes are formed in centers of the first cam and the second cam so that the rotating shaft extending from the knob is movable forward and backward through the first cam and the second cam.
